(19) United States
(12) Patent Application Publication
(10) Pub. No.: US 2019/0370599 A1
(43) Pub. Date: Dec. 5, 2019

(54) Bounded Error Matching for Large Scale Numeric Datasets

(71) Applicant: International Business Machines Corporation, Armonk, NY (US)

(72) Inventors: Rajmohan C, Bangalore (IN); Srikanta Bedathur, New Delhi (IN)

(21) Appl. No.: 15/991,453

(22) Filed: May 29, 2018

(51) Int. Cl. G06K 9/62; G06F 9/30; G06F 17/30; G06F 17/17

(52) U.S. Cl. CPC G06K 9/6201; G06F 9/30025; G06F 17/175; G06F 17/30696; G06F 17/3066

(57) ABSTRACT

Systems and methods are provided for bounded error matching of large scale numeric datasets. For example, a method includes generating a first synopsis for a first numeric dataset maintained in a data repository, receiving a user query to search for numeric datasets in the data repository which are related to a second numeric dataset, generating a second synopsis of the second numeric dataset, performing a hounded error matching process based on an error threshold value by comparing the second synopsis to the first synopsis to determine a match score between the first and second numeric datasets, the match score providing a measure of similarity between the first and second synopses, and responsive to results of the bounded error matching process, returning a query result to the user, which includes an identification of the first numeric dataset and the determined match score between the first and second numeric datasets.

### TECHNICAL FIELD

This disclosure relates generally to data processing systems and, more particularly, to systems and methods for determining similarity between elements of numeric datasets.

### BACKGROUND

For various applications, quantifying a similarity between two datasets of elements in terms of the number of elements in common between the two datasets is a fundamental problem that appears in a variety of data integration settings. For example, if the datasets correspond to data columns in different data tables, and the datasets are found to be similar, then it can imply some form of relationship (e.g., containment, primary key-foreign key (PK-FK), the ability to join, etc.} to exist between the two data columns. Various data processing techniques have been proposed for use in a wide range of data discovery solutions to either accurately estimate or exactly measure the similarity between elements in large datasets. However, there has been minimal research and development of data processing techniques that are configured to measure similarity when the elements comprise numerical data, which do not exactly match each other, but which are similar to each other to some degree.

### SUMMARY

Embodiments of the invention generally include systems and methods for bounded error matching of large scale numeric datasets. For example, one embodiment includes a method which comprises: generating a first synopsis data structure of a first numeric dataset maintained in a data repository; receiving a user query to search for numeric datasets in the data repository which are related to a second numeric dataset; generating a second synopsis data structure of the second numeric dataset; performing a bounded error matching process based on an error threshold value, wherein the bounded error matching process comprises comparing the second synopsis data structure to the first synopsis data structure, thereby determining a match score between the first and second numeric datasets, wherein the match score provides a measure of similarity between the first and second synopsis data structures of the first and second numeric datasets; and responsive to results of the bounded error matching process, returning a query result to the user, wherein the query result comprises an identification of the first, numeric dataset and the determined match score between the first and second numeric datasets.

Another embodiment includes a method which comprises: maintaining a plurality of numeric datasets in a data repository; generating synopsis data structures for each of the plurality of numeric datasets in the data repository, wherein the synopsis data structures are constructed based on an error threshold value; generating a synopsis index comprising a plurality of index entries, wherein each index entry comprises a mapping of a given one of the synopsis data structures to an identifier of a corresponding numeric dataset in the data repository; receiving a user query to search for target numeric datasets in the data repository which are related to a source numeric dataset specified by the user query; generating a source synopsis data structure of the source numeric dataset based on the error threshold value; searching through the index entries of the synopsis index and identifying synopsis data structures of target numeric datasets which have elements in common with elements of the source synopsis data structure; determining a match score between the source synopsis data structure and each of the identified synopsis data structures, thereby generating a plurality of match scores, wherein a given match score provides a measure of similarity between the source numeric dataset and a given target numeric dataset in the data repository corresponding to a given one of the identified synopsis data structures; and returning a query result to the user, wherein the query result comprises a ranked list which identifies a plurality of target numeric datasets in the data repository having highest-ranking match scores, out of the plurality of match scores, to the source numeric dataset.

Other embodiments will be described in the following detailed description of embodiments, which is to be read in conjunction with the accompanying figures.

### BRIEF DESCRIPTION OF THE DRAWINGS

FIG. 1 schematically illustrates a system which comprises a data processing platform that is configured to perform bounded error matching of large scale numeric datasets, according to an embodiment of the invention.

FIG. 2 schematically illustrates a one-dimensional (1-D) hounded error matching process for numeric datasets.

FIG. 3 is a flow diagram of a method for performing hounded error matching of numeric datasets, according to an embodiment of the invention.

FIG. 4 schematically illustrates a method for mapping a two-dimensional (2-D) numeric dataset to a 1-D numeric dataset to support bounded error matching of numeric datasets, according to an embodiment of the invention.

FIG. 5 illustrates exemplary 2-D space filling curves that can be utilized to perform a curve mapping process to map a 2-D numeric dataset to a 1-D numeric dataset to support bounded error matching of numeric datasets, according to an embodiment of the invention.

FIG. 6 illustrates exemplary three-dimensional (3-D) space filling curves that can be utilized to perform a curve mapping process to map a 3-D numeric dataset to a 1-D numeric dataset to support bounded error matching of numeric datasets, according to an embodiment of the invention.

FIG. 7 is a flow diagram of a method for performing bounded error matching of numeric datasets, according to another embodiment of the invention.

FIG. 8 is a system diagram of an exemplary computer system on which at least one embodiment of the invention can be implemented.

FIG. 9 depicts a cloud computing environment according to an embodiment of the present invention.

FIG. 10 depicts abstraction model layers according to an embodiment of the present invention.

### DETAILED DESCRIPTION OF EMBODIMENTS

Embodiments of the invention will now be discussed in further detail with regard to systems and methods for bounded error matching of large scale numeric datasets. Exemplary systems and methods discussed herein are configured to construct synopsis data structures (e.g., K-minimum Value (KMV) synopsis data structures) for numeric datasets based on a pre-specified error threshold value, and utilize the synopsis data structures to perform bounded error matching of large scale numeric datasets in an efficient manner. In the absence of a pre-specified error threshold value, systems and methods systems for bounded error matching are configured to construct a spectrum (or set) of synopsis data structures for each numeric dataset at varying error threshold values, and utilize the sets of synopsis data structures to perform bounded error matching of large scale numeric datasets.

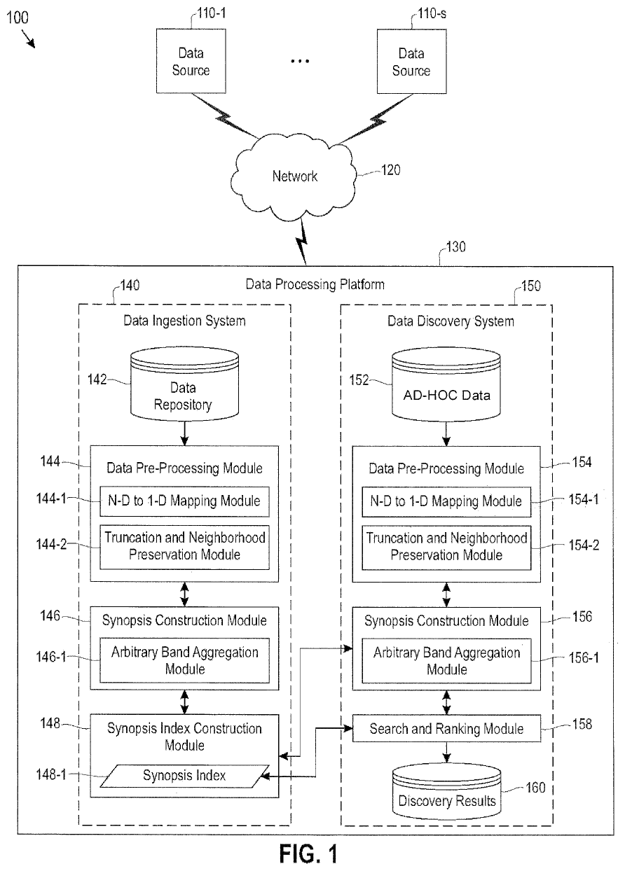

FIG. 1 schematically illustrates a system which comprises a data processing platform that is configured to perform bounded error matching of large scale numeric datasets, according to an embodiment of the invention. In particular, FIG. 1 illustrates a system 100 comprising a plurality of data sources 110-1, . . . , 110-s (collectively, data sources 110), a communications network 120, and a data processing platform 130. The data processing platform 130 comprises a data ingestion system 140 and a data discovery system 150. The data ingestion system 140 comprises a data repository 142 (or data lake), a data pre-processing module 144, a synopsis construction module 146, and a synopsis index construction module 148. The data pre-processing module 144 comprises a multi-dimensional (N-D) to 1-D data mapping module 144-1, and a data truncation and neighborhood preservation module 142-2. The synopsis construction module 146 comprises an arbitrary band aggregation module 146-1. The synopsis index construction module 148 constructs and maintains a synopsis index 148-1. The data discovery system 150 comprises a repository of ad-hoc data tables 152, a data pre-processing module 154, a synopsis construction module 156, a search and ranking module 158, and a repository of discovery results 160. The data pre-processing module 154 comprises an N-D to 1-D data mapping module 154-1, and a data truncation and neighborhood preservation module 154-2. The synopsis construction module 156 comprises an arbitrary band aggregation module 156-1.

The data processing platform 130 can be implemented in various applications in which the processing, analysis, and querying of large numeric datasets and numeric data streams are needed for information management, including, but not limited to, financial applications, IoT (Internet of Things) data processing, database query optimization (e.g., spatial database processing), network monitoring, discovery of metadata features, etc. The data ingestion system 140 implements methods that are configured to perform off-line processing of numeric datasets stored in the data repository 142 to build synopsis data structures for the numeric datasets, and generate a synopsis index data structure which maps the synopsis data structures to corresponding datasets within the data repository 142. The data discovery system 150 implements methods that are configured to perform on-line processing of numeric datasets (e.g., data columns of data tables) stored in the ad-hoc data repository 152 to build synopsis data structures for the numeric datasets stored in the ad-hoc data repository 152, and perform bounded error data matching and searching functions using the synopsis data structures to find numeric datasets within the data repository 142 which are the same or similar to the numeric datasets in the ad-hoc data repository 152. The functions of the data ingestion system 140 and the data discovery system 150 (and constituent data processing modules) will be explained in further detail below.

The data sources 110 include various types of computing systems or devices such as desktop computers, servers, smart phones, electronic tablets, laptop computers, sensors (e.g., IoT network) etc., which upload or stream numerical data and/or numeric datasets to the data processing platform 130 over the communications network 120 for, e.g., storage in the data repository 142 and/or real-time processing by the data discovery system 150. The communications network 120 may comprise any type of communications network (or combinations of networks), such as a global computer network (e.g., the Internet), a wide area network (WAN), a local area network (LAN), a satellite network, a telephone or cable network, a cellular network, a wireless network such as Wi-Fi or WiMAX, or various portions or combinations of these and other types of networks.

While the data processing platform 130 is generically illustrated in FIG. 1 for illustrative purposes, it is to be understood that the various system modules 140 and 150 (and constituent modules thereof) may be distributed over a plurality of computing nodes (e.g., a cluster of servers, virtual machines, etc.) that collectively operate to implement the functions described herein. In addition, the data repositories 142 and 152 may be implemented using any suitable type of data storage protocol and supported by any suitable data storage system or combination of data storage systems, including, but not limited to storage area network (SAN) systems, direct attached storage (DAS) systems, a serial attached storage (SAS/SATA) system, as well as other types of data storage systems comprising clustered or distributed virtual and/or physical infrastructure. The data processing platform 130 may be implemented in a data center or a cloud computing platform that performs data computing and data storage functions to provide services for bounded error matching of large scale numeric datasets to multiple end users, service providers, and/or organizations.

In one embodiment, the data repository 142 comprises a data lake. A data lake comprises a storage repository which stores a vast amount of raw numerical data in a native format. In one embodiment, the data repository 142 stores datasets of raw numerical data that are received from the data sources 110 for one or more target applications. In one embodiment, the data repository 142 comprises a data lake of numeric datasets comprising numerical data organized in data structures. For example, the numerical data can be maintained in columns of data table structures, wherein each column of numerical data within a data table comprises a numeric dataset. The data repository 142 can store a large amount of numerical data on the order of gigabytes to petabytes.

By way of example, in an IoT application domain, an IoT network may comprise a plurality (S) of temperature sensor devices which record temperature values, wherein the number S of temperature sensor devices can be on the order of hundreds, or thousands, or more. The IoT network can be configured to continuously or periodically batch upload the recorded temperature data of the temperature sensor devices to the data repository 142, wherein the temperature data is maintained in a data table structure, as follows:

| Sensor_1 | Sensor_2 | | Sensor_S |
|---|---|---|---|
| Temperature | Temperature | | Temperature |
| Readings | Readings | . . . | Readings |
| 31.83 | 31.7 | . . . | 50.2 |
| 32.01 | 32.1 | . . . | 51.1 |
| 32.15 | 32.3 | . . . | 50.8 |
| 31.99 | 31.9 | . . . | 50.5 |
| 31.67 | 31.5 | . . . | 50.3 |
| . . . | . . . | . . . | . . . |

The example data table comprises columns of numerical temperature data, wherein each data column (numeric dataset) corresponds to a given temperature sensor device (Sensor_1, Sensor_2, . . . , Sensor_S) in the IoT network. While only 5 numerical temperature values are shown in each column of the data table for ease of illustration, depending on the application, each column of data (dataset) can have hundreds, thousands, or even millions of numerical values. Moreover, while the numerical data in the above example data table comprise one-dimensional numerical data, in other applications, each numerical data element may comprise multi-dimensional numerical values. For example, in spatial database processing, a spatial database may comprise location data (i.e., spatial coordinates) wherein each data element comprises multiple numerical elements to represent objects defined in a 2-D or 3D geometric space.

As further shown in the above example data table, while the temperature values for Sensor_1 and Sensor_2 do not exactly match, the data values are similar to some degree (within a bounded error threshold) such that the two datasets of temperature readings for Sensor_1 and Sensor_2 can be deemed matching for purposes of asset matching and discovery, using bounded error matching techniques for numeric datasets as discussed herein. Similarly, in spatial database processing, a spatial database can contain multiple data points that are deemed to be located near each other in geometric space within a small distance error threshold.

When the datasets stored in the repositories 142 and 152 comprise a large number of numerical elements, it is impractical and inefficient to implement standard hounded error matching techniques to determine relationships between numeric datasets, for reasons discussed in further detail below. In this regard, the data processing platform 130 implements methods that are configured to perform bounded error matching across large numeric datasets in an efficient manner using synopsis data structures that are constructed for the numeric dataset.

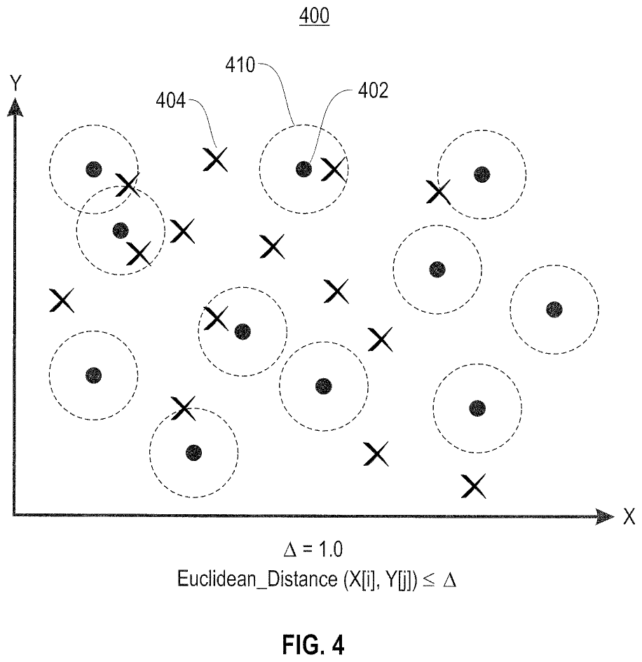

In particular, in the data ingestion system 140, the data pre-processing module 144 implements methods that are configured to pre-process datasets within the data repository 142 to map the datasets into a format for processing by the synopsis construction module 146. In particular, the N-D to 1-D data mapping module 144-1 implements methods that are configured to map a multi-dimensional dataset to a one-dimensional dataset (e.g., map multi-dimensional numerical elements of a dataset to 1-D numerical elements) to support the methods for 1-D bounded error matching of numeric datasets according to embodiments of the invention. For example, as explained in further detail below (e.g., FIGS. 4, 5 and 6), well-known space filling curve techniques can be utilized to map multi-dimensional numerical data elements to one-dimensional numerical data elements. The N-D to 1-D data mapping module 144-1 is an optional module that is only utilized in embodiments of the data processing platform 130 configured for processing multi-dimensional numeric datasets stored in the data repository 142.

The data truncation and neighborhood preservation module 144-2 implements truncation and neighborhood preservation methods that are configured to process a given dataset D (either a raw 1-D dataset stored in the data repository 142 or a 1-D dataset (of a N-D dataset) generated by the N-D to 1-D mapping module 144-1). The data truncation and neighborhood preservation module 144-2 performs a truncation operation on a given dataset D to truncate the numerical elements of the dataset D and generate a truncated dataset (denoted, T_{D}). In one embodiment, the truncation operation involves converting real-number values of the dataset D (e.g., values with a fractional part) to integer values (values with no fractional part) such that the elements of the truncated dataset T_{D} comprise integer values only.

In addition, the data truncation and neighborhood preservation module 144-2 performs a neighborhood preservation operation on the given dataset D to generate a neighborhood preserved dataset (denoted N_{D}) based on the numerical elements of the given dataset D, the truncated dataset T_{D}, and a given error threshold value Δ (or band size). As explained in further detail blow, the neighborhood preservation operation determines, for each numerical element D[i] in the dataset D, if the numerical element D[i] is less than the sum of Δ and the corresponding truncated data value T_{D}[i] of the truncated dataset T_{D}. If so, then a corresponding neighborhood preserved value N_{D}[i] for the numerical element D[i] is set equal to the truncated data value T_{D}[i] minus 2Δ, otherwise the corresponding neighborhood preserved value N_{D}[i] for the numerical element D[i] is set equal to a sum of the truncated data value T_{D}[i] and 2Δ.

As explained in further detail below, the methods implemented by the data pre-processing module 144 (e.g., data truncation and neighborhood preservation operations) serve to convert the raw numerical data of the datasets within the data repository 142 into a domain that facilitates exact value matching between 1-D elements of synopsis data structures (which are generated for the datasets) to identify similar/related datasets. Exemplary methods for performing data truncation and neighborhood preservation operations will be explained in further detail below with reference to example datasets.

The synopsis construction module 144 implements methods that are configured to build synopsis data structures (or sketches) which are summary representations of the numeric datasets stored in the data repository 142. For example, in one embodiment, the synopsis construction module 146 implements methods for constructing K-minimum Value synopsis data structures (or KMV synopsis) for numeric datasets using known techniques. As is known in the art, a KMV synopsis is generated using a single hash function that is selected for the given dataset domain, wherein the hash function is selected such that hash values of the dataset are evenly distributed over the hash space. With the KMV process, the single hash function is utilized to compute a hash value (V) for every element of a given numeric dataset is hashed by one hash function (without the need of a min-wise independent family of hash functions). The KMV process generates a KMV synopsis data structure (or signature) KMV={V1, V2, V3, . . . V_{K}) which comprises the K smallest hash values V computed over the elements in the dataset. The KMV synopsis construction process provides a lightweight and accurate summarization technique to construct distinct value sketches. In other embodiments, the synopsis construction module 146 can build other types of synopsis data structures such as “min-hash” synopsis data structures, wherein the min-hash process utilizes multiple hash functions to compute sketches, as is known in the art.

The process of performing bounded error matching across large scale numeric datasets is challenging and non-trivial for reasons discussed herein. While each numeric dataset in the data repository 142 can have a large number of numerical elements on the order of thousands or millions of numerical elements, the synopsis data structures that are generated for the datasets comprise a relatively smaller number of numerical elements (e.g., K elements for KMV sketches). In this regard, embodiments of the invention utilized the synopsis data structures to perform bounded error matching of the numeric dataset, wherein dataset operations (union, intersection, etc.) can be efficiently performed using the KMV synopsis data structures (as opposed to the raw large scale numeric datasets).

Since KMV relies on hashing instance values, KMV does not naturally support instance matching with bounded error (approximate matching). In this regard, the methods implemented by the data pre-processing module 144 (e.g., data truncation and neighborhood preservation operations) serve to convert the raw numerical data of the datasets within the data repository 142 into a domain that facilitates hounded error value matching between 1-D elements of synopsis data structures which are generated for the datasets and utilized to identify similar/related datasets. For example, in one embodiment, a synopsis data structure S_{D} for a given dataset D is generated by constructing a KMV synopsis for a dataset comprising a UNION of the truncated dataset T_{D} and neighborhood preserved dataset N_{D} for the given dataset D, i.e., S_{D}=KMV{T_{D}∪N_{D}}.

The synopsis index construction module 148 implements methods that are configured to build and/or update a synopsis index structure 148-1 for mapping the raw numeric datasets in the data repository 142 to the corresponding synopsis data structures that are generated by the synopsis construction module 146. The synopsis index 148-1 comprises a data structure which maps the signatures of the synopsis data structures to unique dataset identifiers (dataset ID) corresponding to the datasets in the data repository 142. For example, the synopsis index 148-1 can be structured in a tabular form as follows:

| Synopsis Signature (S_{D[i]}) | Dataset ID |
|---|---|
| (V1, V2, V3, . . . , V_{K}) | D1 |
| (V1, V2, V3, . . . , V_{K}) | D2 |
| . . . | . . . |
| (V1, V2, V3, . . . , V_{K}) | Dₜ |

In this example, the synopsis index 148-1 comprises a plurality (t) of rows, wherein each row maps a synopsis data structure S_{D[i]} (i=1, 2, 3, . . . , t) (or synopsis signature) to a corresponding dataset ID (D1, D2, . . . , Dₜ) of a target dataset D maintained in the data repository 142. In one embodiment, each synopsis signature S_{D[i]} comprises a set of K-minimum hash values (V1, V2, V3, . . . , V_{K}) of a KMV signature, which are computed over the numerical elements of the dataset {T_{D[i]}∪N_{D[i]}} for a given dataset D[i], i.e., S_{D[i]}=KMV{T_{D[i]}∪N_{D[i]}}.

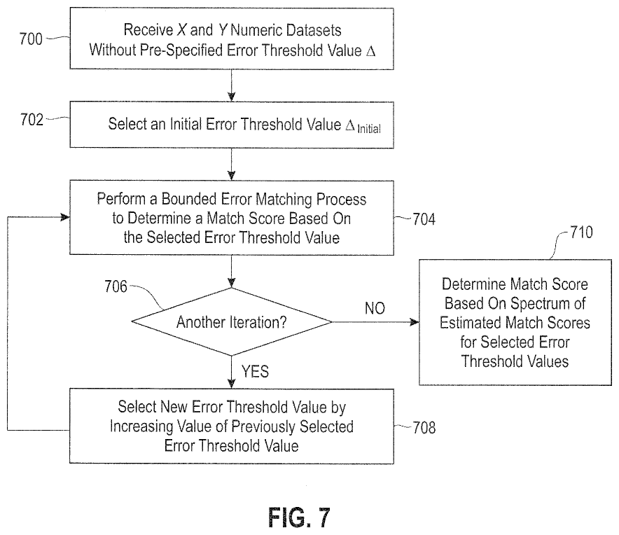

In one embodiment, the data pre-processing module 144 and the synopsis construction module 146 perform respective data processing functions based on a pre-specified error threshold value Δ (e.g., user/customer-specified error threshold). In this embodiment, one synopsis data structure is constructed for each dataset (e.g., data column) in the data repository 142 (for a given user/customer) based on the pre-specified error threshold value Δ. In other embodiments, in the absence of a pre-specified error threshold value Δ, the arbitrary band aggregation module 146-1 implements methods that are configured to generate a plurality (x) of different error threshold values (Δ₁, Δ₂, . . . Δₓ) according to a pre-specified protocol or set of rules, etc. In this situation, a plurality (x) of synopsis data structures are constructed for each dataset (e.g., data column) in the data repository 142, wherein each synopsis data structure for a given dataset is constructed based on one of the error threshold values within the set of error threshold values (Δ₁, Δ₂, . . . Δₓ). Exemplary operating modes of the arbitrary band aggregation module 146-1 will be discussed in further detail below with reference to the flow diagram of FIG. 7.

The data discovery system 150 implements methods that are configured to perform “on-line” bounded error matching of numeric datasets in the ad-hoc data repository 152 with numeric datasets maintained in the data repository 142. In one embodiment, the ad-hoc data repository 152 comprises a repository of ad-hoc datasets (e.g., ad-hoc data tables) which may be dynamically generated “on the fly” as a result of a database query (e.g., SQL query). In addition, the ad-hoc data may comprise datasets that are batch uploaded or streamed to the data processing platform 130 from the data sources 110 for processing and storage. The ad-hoc data may comprise manually constructed datasets. The data discovery system 150 is configured to process user/client queries to identify existing datasets stored in the data repository 142 which are similar or related to ad-hoc datasets in the ad-hoc data repository 152.

The data pre-processing module 154 (and constituent modules 154-1 and 154-2) in the data discovery system 150 perform the same or similar functions as the data pre-processing module 144 (and constituent modules 144-1 and 134-2) in the data ingestion system 140. Likewise, the synopsis construction module 156 and the arbitrary band aggregation module 156-1 in the data discovery system 150 perform the same or similar functions as the synopsis construction module 146 and the arbitrary band aggregation module 146-1 in the data ingestion system 140.

The data discovery system 150 can be utilized to perform a bounded error matching process to determine a set (e.g., ranked list) of one or more existing datasets (or target datasets) in the data repository 142 which are related to, or otherwise match, a given dataset D (or source dataset) in the ad-hoc data repository 152. In one embodiment, assuming that the bounded error matching is performed based on a pre-specified error threshold value Δ, the data pre-processing module 154 and the synopsis construction module 156 would process the source dataset D using techniques as discussed herein to generate one synopsis data structure S_{D} (e.g., KMV synopsis) for the source dataset D based on the pre-specified error threshold value Δ. As noted above, for a KMV synopsis, the synopsis data structure S_{D} for the source dataset D would comprise a set of K numerical elements (V1, V2, V3, . . . , V_{K}) representing a KMV signature of the source dataset D. In other embodiments, as noted above, in the absence of a pre-specified error threshold value Δ, the arbitrary band aggregation module 156-1 will generate a plurality (x) of different error threshold values (Δ₁, Δ₂, . . . Δₓ) and the synopsis construction module 156 will generate a plurality (x) of synopsis data structures for the source dataset D, one for each error threshold value (Δ₁, Δ₂, . . . Δₓ). Exemplary operating modes of the arbitrary band aggregation module 156-1 will be discussed in further detail below with reference to the flow diagram of FIG. 7.

The search and ranking module 158 implements methods that are configured to perform various functions such as (i) searching the synopsis index 148-1 to identify synopsis signatures (of target datasets) which have one or more elements that match one or more elements of the synopsis signature S_{D} of the source dataset D, (ii) computing a match score (or similarity score) between the synopsis signature S_{D} of the source dataset D and each of the synopsis signatures in the synopsis index 148-1 which are determined to have one or more elements in common with the synopsis signature S_{D} of the source dataset D, and (iii) generating a ranked list which identifies a plurality of target datasets in the data repository 142 having the highest-ranking match scores to the source dataset D. The search and ranking module 158 will store the ranked list the data store of discovery results 160.

In one embodiment, the search process implemented by the search and ranking module 158 involves performing an intersection operation between the synopsis signature S_{D} of the source dataset D and the synopsis signature S_{D[i]} (i.e., S_{D}∩S_{D[i]}) for each entry in the synopsis index 148-1, to determine the intersection size between the source S_{D} and each target S_{D[i]}. In this regard, the intersection size between the source signature S_{D} and a target signature S_{D[i]} in the synopsis index 148-1 corresponds to the number (n) of elements in S_{D[i]} which equi-match elements in S_{D}. Further, in one embodiment where the source and target signatures S_{D} and S_{D[i]} each have K elements, the match score (S) between the source S_{D} and a given target S_{D[i]} is computed as S=(n/K) %. Moreover, in one embodiment, the search and ranking module 158 will compare the match score (S) (which is computed between the source S_{D} and a given target S_{D[i]}) to a minimum score threshold value (T_{S}), such that a target dataset D will be included in the ranked list if the associated match score S meets T_{S} (e.g., S≥T_{S}).

In one embodiment, when the data discovery system 150 is utilized to match a source dataset D in the ad-hoc data repository 152 to target datasets in the data repository 142 to find matching datasets as discussed above, the source dataset D will be pre-processed using a truncation operation (but not neighborhood preservation) to generate a truncated dataset T_{D}, and a synopsis data structure S_{D} will be generated for the truncated dataset T_{D}. For example, for a KMV synopsis, the truncation and neighborhood preservation module 154-2 will generate the truncated dataset T_{D} and the synopsis construction module 156 will generate a KMV synopsis data structure S_{D}=KMV{T_{D}}). In this regard, the KMV synopsis data structure S_{D} is generated truncated using the dataset T_{D} alone, without a neighborhood preserved dataset N_{D}. In this instance, only a truncation operation is applied to the numerical values of the source dataset D since the query seeks to identify target datasets in the data repository 142 which match to the source dataset D.

Thereafter, the data ingestion system 140 can be utilized to store the source dataset D in the data repository 142, generate a new synopsis data structure S_{D} for the newly added dataset D, and update the synopsis index 148-1 to include a new entry which maps the new synopsis data structure to the newly added dataset D. In particular, with this process, the truncation and neighborhood preservation module 144-2 can generate a truncated dataset T_{D} and neighborhood preserved dataset N_{D} for the newly added dataset D, the synopsis construction module 146 will construct a synopsis data structure S_{D} for the newly added dataset D using the truncated dataset T_{D} and neighborhood preserved dataset N_{D} for the given dataset D, e.g., S_{D}=KMV{T_{D}∪N_{D}}, and the synopsis index construction module 148 will update the synopsis index 148-1 to include the new entry for synopsis S_{D} associated with the newly added dataset D in the data repository.

In one embodiment, to implement and efficient distributed computing framework, the data pre-processing modules 144 and 154 can be configured to convert the datasets (e.g., raw, truncated, and neighborhood preserved datasets) into a resilient distributed dataset (RDD) data structures using the known Apache Spark platform. As is known in the art, a RDD is an immutable distributed collection of elements or objects (e.g., Java, Scala, Python, and user defined functions) over a cluster. An RDD is a read-only, partitioned collection of records, which can be created through deterministic operations on data that is contained in one or more datasets or in other RDDs. Each dataset in RDD is divided into logical partitions, which may be computed on different nodes of a cluster and operated on in parallel. RDD supports in-memory processing computation, i.e., RDD stores the state of memory as an object across multiple jobs and the object is sharable between the multiple jobs. The data sharing in memory allows different queries to be run on the same set of data repeatedly, so the data can be kept in memory for better execution times.

Embodiments of the invention provide techniques to modify standard bounded error matching and set relatedness concepts in a way which maps a conventional non-equi bounded error instance matching process to an exact instance matching process, to enable matching of large scale numeric datasets using synopsis data structures in an efficient manner. In particular, given numeric datasets X and Y and a specified error threshold value Δ (or band), a conventional bounded error matching process involves determining for each numerical element X[i] in the dataset X, at least one numerical element Y[j] in the dataset Y which satisfies the following condition:

Y[j]−Δ≤X[i]≤Y[j]+Δ Eqn. (1).

In other words, given two numerical values X[i] and Y[j] and the specified error threshold value Δ for matching, the value X[i] will be deemed to match the value Y[j], if an only if (iff) the condition of Eqn. (1) is satisfied, i.e. X[i] falls within the specified band Δ of Y[j].

Further, a set relatedness between the numeric datasets X and Y is defined as follows. Given a specified error threshold Δ, dataset X matches dataset Y (denoted as X→Y) with a support value “S”, where “S” denotes a percentage of numerical elements X[i] in the dataset set X that satisfy the condition (Y[j]−Δ≤X[i]≤Y[j]+Δ) for at least one numerical element Y[j] in the dataset Y. In other words, “S” denotes a percentage of numerical elements X[i] in the dataset X that fall within a specified band of a numerical element Y[j] in the dataset Y. If the support value (S) (or match score) is greater than a minimum support threshold value (T_{S}), then the dataset X is deemed to be related to the dataset Y:

$$X {\to }^{s} Y .$$

In particular, assuming there are “k” numerical elements X[i] in the dataset X, and that there are “n” out of “k” numerical elements X[i] in the dataset X for which there is a least one numerical element Y[j] which satisfies the condition Y[j]−Δ≤X[i]≤Y[j]+Δ, then it is deemed that X→Y (or X matches Y) with a support value (s) of (n/k)*100%.

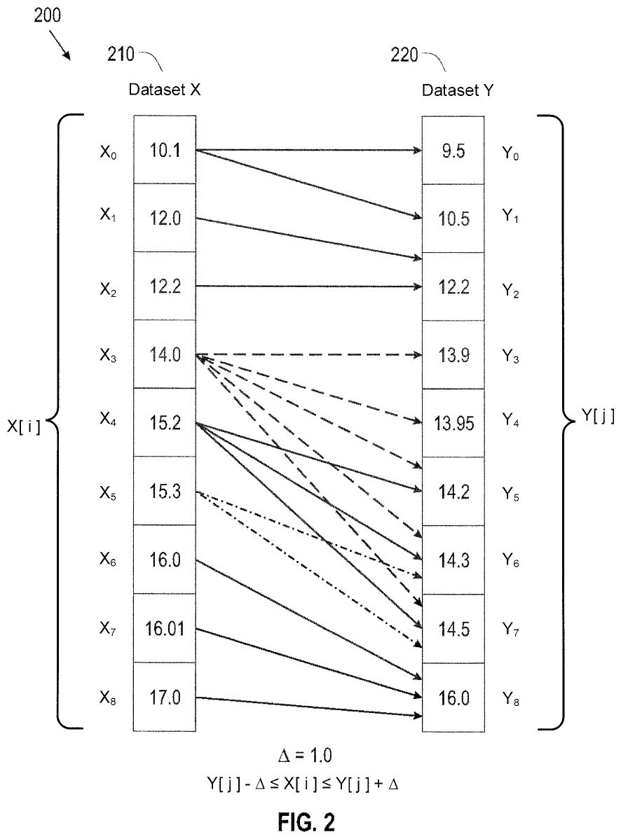

FIG. 2 schematically illustrates a one-dimensional bounded error matching process for numeric datasets. In particular, FIG. 2 schematically illustrates a one-dimensional bounded error matching process 200 for matching a first numeric dataset 210 (dataset X) with a second numeric dataset 220 (dataset Y) with a specified error threshold Δ=1.0. The dataset X comprises a set of numerical elements X[i] as follows:

| [i] | 0 | 1 | 2 | 3 | 4 | 5 | 6 | 7 | 8 |
|---|---|---|---|---|---|---|---|---|---|
| X | 10.1 | 12.0 | 12.2 | 14 | 15.2 | 15.3 | 16 | 16.01 | 17 |

wherein [i] represents an index for the numerical elements X[i] in the dataset X.

Furthermore, the dataset Y comprises a set of numerical elements Y[j] as follows:

| [j] | 0 | 1 | 2 | 3 | 4 | 5 | 6 | 7 | 8 |
|---|---|---|---|---|---|---|---|---|---|
| Y | 9.5 | 10.5 | 12.2 | 13.9 | 13.95 | 14.2 | 14.3 | 14.5 | 16 |

wherein [j] represents an index for the numerical elements Y[j] in the dataset Y. Assuming a pre-specified error threshold value Δ=1.0, a conventional bounded error matching process for matching the datasets X and Y within a bounded error Δ to obtain a X→Y match score (or similarity score) is implemented as follows.

In the illustrative embodiment of FIG. 2, given two numeric values X[i] and Y[j] and the specified error threshold value for matching (Δ=1.0). X[i] will be deemed to match Y[j] iff (Y[j]−Δ≤X[i]≤Y[j]+Δ). For example, if we want to know whether X₀=10.1 falls within the band of Y₀=9.5 for a band size (Δ) of 1.0, a determination is made as to whether the condition 9.5−1.0≤10.1≤9.5+1.0 is true or not. Since the condition is true, it is determined that there is at least one numerical element Y[j] in the dataset Y which matches the numerical element X₀ of the dataset X.

By applying the bounded error matching process with the specified match error (Δ=1.0) to the numeric elements of the datasets X and Y shown in FIG. 2, we see that (i) element X₀ matches elements Y₀ and Y₁, (ii) element X₁ matches element Y₂, (iii) element X₂ matches element Y₂, (iv) element X₃ matches elements Y₃, Y₄, Y₅, Y₆ and Y₇, (v) element X₄ matches elements Y₅, Y₆, and Y₇, (vi) element X₅ matches elements Y₆ and Y₇, (vii) element X₆ matches element Y₅, (viii) element X₇ matches element Y₈, and (ix) element X₈ matches element Y₈. In this regard, we see that every element X[i] in the dataset X matches to at least one element Y[j] in the dataset Y, which results in a support score (S) of 100%.

The conventional bounded error matching process illustrated above for datasets X and Y is inefficient and impractical for large scale numeric datasets. For example, the bounded error matching process requires two (2) inequality check operations to be performed for each pair of numerical elements X[i] and Y[j] in the datasets X and Y, which is computationally expensive. Bounded error matching techniques according to embodiments of the invention eliminate the need to perform inequality checks and utilize equality check operations instead (which are computationally less expensive) to determine matching scores between datasets. In accordance with embodiments of the invention, truncation and neighborhood preservation processes, as well as synopsis data structures, are utilized to map the conventional bounded error matching problem into an equality matching problem. An exemplary process for matching a dataset X with a dataset Y using a bounded error matching process which implements truncation and neighborhood preservation processes, as well as synopsis data structures, will now be discussed in further detail.

In one embodiment, assume we have numeric datasets X and Y comprising numerical elements. Given a pre-specified error threshold value Δ, a truncation operation is performed on the numeric datasets X and Y as follows:

$$\begin{matrix}{T}_{X} = 2 Δ \times Math \cdot floor ( \frac{X}{2 Δ} ) & Eqn . ( 2 ) \\ {T}_{Y} = 2 Δ \times Math \cdot floor ( \frac{Y}{2 Δ} ) , & Eqn . ( 3 )\end{matrix}$$

wherein T_{X} and T_{Y} denote truncated datasets X and Y, respectively, and wherein Math·floor denotes a method that is performed on each numeric element of the datasets X and Y. For each numeric element, the Math·floor method returns the largest (closest to positive infinity) floating-point value which is less than or equal to the argument, and which is equal to a mathematical integer. For example, the Math·floor( ) function in JavaScript is utilized to round off a real number passed as parameter to its nearest integer in a downward direction of rounding towards the lesser value. For example, a real number of 5.7 or 5.3 would be truncated to an integer value of 5.0. The truncation operations serve to convert real-number values of the numerical elements of a given dataset to integer values with no decimal (fractional) portions.

When determining the relationship X→Y, a neighborhood preservation operation is performed (using the dataset Y and the corresponding truncated dataset T_{Y}) to generate a neighborhood preserved dataset N_{Y} as follows:

If Y<T_{Y}+Δ, then N_{Y}=T_{Y}−2Δ, else N_{Y}=T_{Y}+2Δ Eqn. (4).

The neighborhood preservation operation is based on the premise that for each element Y[j] of the dataset Y, all elements X[i] of the dataset X falling within the error band Δ of Y[j] must have truncated values T_{X}[i] that are equal to either (i) the truncated value T_{Y}[j] of the truncated dataset T_{Y} minus 2Δ or (ii) the truncated value T_{Y}[j] of the truncated dataset T_{Y} plus 2Δ. Then, the problem of relating X and Y by bounded error matching involves finding an equi-match between the truncated dataset T_{X} and a dataset comprising a UNION of the truncated dataset T_{Y} and the neighborhood preserved dataset N_{Y}, i.e., (T_{Y}∪N_{Y}). Further, an efficient bounded error matching is performed using synopsis data structures (e.g., KMV synopsis).

For illustrative purposes, a bounded error matching process for matching the datasets X and Y of FIG. 2 within a bounded error Δ=1.0 using truncation and neighborhood preservation functions to obtain a X→Y match score is as follows. An initial step involves performing a truncation operation on the dataset X to determine a truncated dataset T_{X} by applying the transformation T_{X}[i]=2Δ*Math·floor(X[i]/2Δ) to all numerical elements X[i] of the dataset X. The truncation of the dataset X={10.1, 12.0, 12.2, 14, 15.2, 15.3, 16, 16.01, 17} results in a truncated dataset T_{X} as follows:

| [i] | 0 | 1 | 2 | 3 | 4 | 5 | 6 | 7 | 8 |
|---|---|---|---|---|---|---|---|---|---|
| T_{X} | 10 | 12 | 12 | 14 | 14 | 14 | 16 | 16 | 16 |

wherein the truncated dataset T_{X}={10, 12, 12, 14, 14, 14, 16, 16, 16}.

A next step is to perform truncation and neighborhood preservation operations on the dataset Y. A truncation operation is performed on the dataset Y to determine a truncated dataset T_{Y} by applying the transformation T_{Y}[j]=2Δ *Math·floor (Y[j]/2Δ) to all numerical elements Y[j] of the dataset Y. The truncation of dataset Y={9.5, 10.5, 12.2, 13.9, 13.95, 14.2, 14.3, 14.5, 16} results in a truncated dataset T_{Y} as follows:

| [j] | 0 | 1 | 2 | 3 | 4 | 5 | 6 | 7 | 8 |
|---|---|---|---|---|---|---|---|---|---|
| T_{Y} | 8 | 10 | 12 | 12 | 12 | 14 | 14 | 14 | 16 |

wherein the truncated dataset T_{Y}={8, 10, 12, 12, 12, 14, 14, 14, 16}.

Next, a neighborhood preservation operation performed for the dataset Y by applying the following transformation to all elements T_{Y}[j] of the truncated dataset T_{Y} as follows:

if Y[j]<T_{Y}[j]+Δ, then N_{Y}[j]=T_{Y}[j]−2Δ, else N_{Y}[j]=T_{Y}[j]+2Δ,

which results in a neighborhood preserved dataset N_{Y}={10, 8, 10, 14, 14, 12, 12, 12, 14}, as follows:

| [j] | 0 | 1 | 2 | 3 | 4 | 5 | 6 | 7 | 8 |
|---|---|---|---|---|---|---|---|---|---|
| N_{Y} | 10 | 8 | 10 | 14 | 14 | 12 | 12 | 12 | 14 |

Essentially, a bounded error matching process according to an embodiment of the invention for matching the dataset X with the dataset Y within the given error threshold value Δ is performed by equi-matching the elements of the truncated dataset T_{X} with elements of dataset={T_{Y}∪N_{Y}} using equality comparisons (as opposed to inequality operations implemented by the conventional bounded error matching process as described above). In this regard, bounded error matching techniques according to embodiments of the invention eliminate the need to perform inequality checks and utilize equality check operations instead (which are computationally less expensive) to determine match scores (or similarity scores) between numeric datasets.

For example, continuing with the above example, if we want to know whether X₀=10.1 falls within the band of Y₀=9.5 for the band (Δ) of 1.0, such determination can be made with equality check operations alone using the truncated datasets T_{X} and T_{Y} and the neighborhood preserved dataset N_{Y}. For example, with this process, it is determined that element X₀ falls within the band of element Y₀ only if the truncated element T_{X0} is equal to at least one of T_{Y0} and N_{Y0}. If T_{X0} is not equal to at least one of T_{Y0} and N_{Y0}, then X₀ is deemed to not fall within the band of Y₀. In this regard, a numerical element X[i] (of the dataset X) falling within the band (Δ) of a numerical element Y[j] of the dataset Y will have a truncated element T_{X}[i] that is equal to either (i) a truncated element T_{Y}[j] in the truncated dataset T_{Y} or (ii) a neighborhood preserved element N_{Y}[j] in the neighborhood preserved dataset N_{Y}.

For example, in the case of numerical elements X₀ and Y₀, since the element T_{X0}=10 and the elements T_{Y0}=8 and N_{Y0}=10, we see that T_{X0}=N_{Y0}, so that elements X₀ and Y₀ are deemed to be matching within the bounded error of Δ=1.0. On the other hand, in the case of the elements X₀ and Y₇, we see that T_{X0} is not equal to either T_{Y7} or N_{Y7}. Therefore, the elements X₀ and Y₇ are deemed as not matching within the bounded error of Δ=1.0, which is consistent with the conventional process illustrated above. However, in the above example, for each element of the truncated dataset T_{X}, we see that there is at least one element in the dataset formed by the union of T_{Y} and N_{Y} (i.e., {T_{Y}∪N_{Y}}) which is equal to the given truncated element. Therefore, there is a 100% bounded error match for X→Y with Δ=1.0.

The methods illustrated above essentially map a bounded error matching problem into an equality matching problem, wherein matching the dataset X to the dataset Y within a bounded error equates to using equality comparison operations for equi-matching elements of the truncated dataset T_{X} with elements of the dataset formed by the union of T_{Y} and N_{Y} (i.e., {T_{Y}∪N_{Y}}). After mapping the numeric datasets X and Y to the respective datasets T_{X} and {T_{Y}∪N_{Y}}, if the datasets T_{X} and {T_{Y}∪N_{Y}} are relatively large in size, the equality check operations can be computationally expensive. In this regard, synopsis data structures can be constructed for the datasets T_{X} and {T_{Y}∪N_{Y}} and utilized to perform equality check operations in more efficient manner to determine a match score between the datasets X and Y.

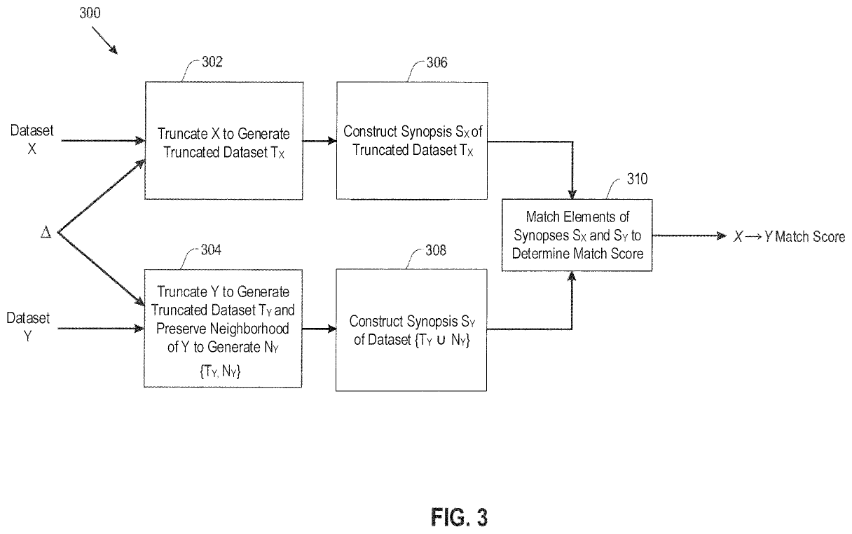

For example, FIG. 3 is a flow diagram of a method 300 for performing a bounded error matching process according to an embodiment of the invention. As shown in FIG. 3, the method 300 receives as input datasets X and Y, and a pre-specified error threshold value Δ. For illustrative purposes, the process flow of FIG. 3 illustrates an example embodiment for determining a relation of dataset X to dataset Y (denoted as X→Y). In this instance, a truncation operation is performed on the dataset X to generate a truncated dataset T_{X} (bock 302) while no neighborhood preservation operation is performed on the dataset X. On the other hand, both a truncation operation and a neighborhood preservation operation is performed on the dataset Y to generate a truncated dataset T_{Y} and a neighborhood preserved dataset N_{Y} (block 304).

In one embodiment, the truncation operations of the datasets X and Y (in blocks 302 and 304) are implemented using Eqns. (2) and (3) in a manner as illustrated above in connection with the example truncation operations performed on the datasets X and Y of FIG. 2, to compute the truncated datasets T_{X} and T_{Y}. Further, in one embodiment, the neighborhood preservation operation (block 304) is implemented using Eqn. (4) in a matter as illustrated above in connection with the example neighborhood preservation operations on the dataset Y of FIG. 2, to compute the neighborhood preserved dataset N_{Y}.

As further illustrated in FIG. 3, a synopsis data structure S_{X} is constructed for the truncated dataset T_{X} (block 306). In addition, a synopsis data structure S_{Y} is constructed for the truncated dataset T_{Y} and the neighborhood preserved dataset N_{Y} (block 308). In one embodiment, the synopsis data structures S_{X} and S_{Y} are KMV synopsis data structures (or KMV signatures) that are constructed using known KMV processing techniques. As is known in the art, a KMV synopsis is generated using a single hash function that is selected for the given dataset domain (wherein the hash function is selected such that hash values of the dataset are evenly distributed over the hash space).

The synopsis data structure S_{X} for the truncated dataset T_{X} can be constructed (in block 306) using a KMV synopsis construction process as follows. During the KMV process, a current list “L” of the K smallest hash values is maintained, and a function (maxVal(L)) is utilized to return the largest hash value in the list L. For each numerical element X[i] in the dataset X, a hash value V is computed by applying the hash function, h( ), to the numerical element X[i] (i.e., V=h(X[i])). If the computed hash value V is not currently in the list L, and if the number of hash values in the list L is less than K, the computed hash value V is added to the list L. On the other hand, if the number of hash values in the list L is equal to K, the function (maxVal(L)) is utilized to return the largest hash value currently in the list L. If the currently computed hash value V is less than the largest hash value currently in the list L, then the computed hash value V is added to the list L, and the returned largest hash value is removed from the list L. This process is repeated for each numerical element X[i] in the dataset X, resulting in a KMV synopsis data structure (or signature) of S_{X}={V1, V2, V3, . . . , V_{K}) which comprises the K smallest hash values V computed over the elements X[i] in the dataset X.

The synopsis data structure S_{Y} for the dataset (T_{Y}∪N_{Y}v can be constructed (in block 308) using the same process flow as described above, resulting in a KMV synopsis data structure (or signature) of S_{Y}={V1, V2, V3, . . . , V_{K}) which comprises the K smallest hash values V computed over the elements in the dataset {T_{Y}∪Nγ}. It is to be noted that in an alternative embodiment, the KMV synopsis data structure S_{Y} for the dataset {T_{Y}∪N_{Y}} (denoted KMV {T_{Y}∪N_{Y}}) can computed by constructing a KMV synopsis signature for the truncated dataset T_{Y} (denoted KMV{T_{Y}} and a KMV synopsis signature for the neighborhood preserved dataset N_{Y} (denoted KMV{N_{Y}}) and then computing synopsis data structure S_{Y} for the dataset {T_{Y}∪N_{Y}} by the UNION of the KMV{T_{Y}} and KMV{N_{Y}} synopses, i.e., KMV{T_{Y}∪N_{Y}}=KMV{T_{Y}}∪KMV{N_{Y}}.

Following the construction of the synopsis data structures S_{X} and S_{Y}, an equality matching operation is performed on the elements of the synopsis data structures S_{X} and S_{Y} to determine a match score (or support S) with regard to X→Y for the datasets X and Y (block 310). In one embodiment, an intersection operation of the synopsis data structures S_{X} and S_{Y} (i.e., S_{X}∩S_{Y}) is performed to determine the set of all elements that are members of both S_{X} and S_{Y}. In this regard, the number (n) of elements within the set {S_{X}∩S_{Y}} denotes a number of elements in S_{Y} which equi-match elements of S_{X}. Since S_{X} and S_{Y} each have K elements, the match score (S) for X→Y is computed as S=(n/K) %.

For purposes of illustration, assume a KMV synopsis size of K=5, wherein the synopsis data structure S_{X} for the dataset X comprises a set of 5 minimum hash values, S_{X}={18828388, 8723737, 1883399, 8373737, 7363279}, and wherein the synopsis data structure S_{Y} for the dataset Y comprises a set of 5 minimum hash values, S_{Y}={18828388, 2773737, 1883399, 8373737, 393939}. In this example, the match score computation process (block 310) would determine that the synopsis S_{Y}={18828388, 2773737, 1883399, 8373737, 393939} for the dataset Y would have 3 out of 5 numerical elements that are equal to numerical elements the synopsis S_{X}={18828388, 8723737, 1883399, 8373737, 7363279} for the dataset X (i.e., 18828388, 1883399, and 8373737). In this regard, the match score for X→Y would be ⅗ (or 60%).

In another embodiment, a match score for Y→X can be computed using the same process flow as discussed above in FIG. 3, except that (i) for the dataset Y, the synopsis data structure S_{Y} would be computed using only the truncated dataset T_{Y}, and (ii) for the dataset X, the synopsis data structure S_{X} would be computed based on the truncated dataset T_{X} and a neighborhood preserved dataset N_{X} (i.e., S_{X}=KMV {T_{X}∪N_{X}}). In another embodiment, a match score for X↔Y can be computed as [(X→Y match score)+(Y→X match score)]/2.

It is to be understood that FIG. 3 illustrates various operating modes of the data processing platform 130 of FIG. 1. For example, in one embodiment, the process flow of FIG. 3 illustrates an operational mode in which the data discovery system 150 in FIG. 1 is utilized to compute (on-line mode) a match score between two datasets X and Y that are stored in the ad-hoc data repository 152. In this embodiment, the truncation and neighborhood preservation processes (blocks 302 and 304) would be performed by the truncation and neighborhood preservation module 154-2, and the synopsis construction processes (blocks 306 and 308) would be performed by the synopsis construction module 156. In addition, the match score computation process (block 310) would be performed by the search and ranking module 158.

In another embodiment, the process flow of FIG. 3 illustrates an operational mode in which the data ingestion system 140 in FIG. 1 is utilized to compute (off-line mode) the synopsis data structure S_{Y} for the dataset Y, wherein it is assumed that the dataset Y is stored in the data repository 142, and that the synopsis index 148-1 comprises an entry which maps the associated synopsis data structure S_{Y}=(V1, V2, V3, . . . , V_{K}) to the dataset Y, i.e., SY→Y. In this embodiment, the truncation and neighborhood preservation module 144-2 is utilized to perform the truncation and neighborhood preservation processes (in block 304) to generate the truncated dataset T_{Y} and the neighborhood preserved dataset N_{Y}, the synopsis construction module 146 is utilized to construct the KMV synopsis data structure S_{Y}=KMV{T_{Y}∪N_{Y}}, and the synopsis index construction module 148 is utilized update the synopsis index 148-1 to include the mapping entry S_{Y}→Y.

Furthermore, in this example embodiment, it is assumed that the data discovery system 150 is utilized to compute (on-line mode) the synopsis data structure S_{X}={V1, V2, V3, . . . , V_{K}) for the dataset X, wherein the dataset X is stored in the ad-hoc data repository 152 and wherein a query is submitted to the data discovery system 150 to identify one or more datasets D (e.g., dataset Y) in the data repository 142 which are similar/related to the dataset X. In this embodiment, the truncation process (block 302) would be performed by the truncation and neighborhood preservation module 154-2 to generate the truncated dataset T_{X}, and the synopsis construction process (block 306) would be performed by the synopsis construction module 156 to generate the synopsis data structure S_{X} based on the truncated dataset T_{X}. In this instance, the synopsis data structure S_{X} is constructed using only the truncated dataset T_{X} (and not a neighborhood preserved dataset N_{X}) since the query seeks to identify datasets D in the data repository 142 which match to the dataset X based on a pre-specified error threshold value (i.e., query requests X→D where is D is an unknown dataset in the data repository 142).

Following construction of the synopsis data structure S_{X} for the dataset X, the search and ranking module 158 will search through the entries of the synopsis index 148-1 to identify synopsis data structures S_{D} associated with datasets D maintained in the data repository 142, which are the same or similar to the synopsis data structure S_{X}. As noted above, the synopsis index 148-1 comprises a plurality of entries, wherein each entry maps a synopsis data structure S_{D} to a corresponding dataset index number (D1, D2, . . . , D_{Y}) of a given dataset D in the data repository 142. For KMV synopsis data structures, each synopsis data structure S_{D} comprises a synopsis signature of K numerical elements (V1, V2, V3, . . . , V_{K}).

In one embodiment, the search process involves performing an intersection operation between the synopsis data structure S_{X} of the dataset X and the synopsis data structure S_{D} (i.e., S_{X} ∩S_{D}) for each entry in the synopsis index 148-1, to determine the intersection size between S_{X} and each S_{D}, and compute a match score (S) for X→D for each dataset D in the data repository 142 corresponding to the S_{D} entries. The search and ranking module 158 would search the entire synopsis index 148-1 to identify other datasets with synopsis data structures that have signatures which match to the synopsis data structure S_{X}, and then generate a ranked list of a plurality (M) of datasets D having the highest-ranking match scores to the dataset X.

Thereafter, the data ingestion system 140 can be utilized to store the dataset X into the data repository 142, generate a synopsis data structure S_{X} (e.g., S_{X}=KMV{T_{X}∪N_{X}}, for the newly added dataset X, and update the synopsis index 148-1 to include a new entry which maps the synopsis data structure S_{X} to the dataset X. In particular, with this process, since the truncated dataset T_{X} and the synopsis KMV{T_{X}} were already computed for the dataset X to perform the search and ranking operations, a neighborhood preservation process is performed to compute a neighborhood preserved dataset N_{X} for the dataset X, and a KMV process is performed to compute a KMV{N_{X}} synopsis, using methods as discussed above. Then, the synopsis signature S_{X} of the dataset X (for which an entry is to be added to the synopsis index 148-1) is computed by the UNION of the KMV{T_{X}} and KMV{N_{X}} synopses, i.e., KMV{T_{Y}∪N_{Y}}=KMV{T_{Y}}∪KMV{N_{Y}}. The synopsis index construction module 148 will update the synopsis index 148-1 to include the new entry for synopsis S_{X} associated with the dataset X that was added to the data repository 142. In this manner, search and ranking module 158 will be able to determine a similarity score between the newly added dataset X and additional datasets that are uploaded or otherwise stored in the ad-hoc data repository 152 for subsequent search and ranking operations that may be performed (on-line) in response to user/client queries.

It is to be appreciated that synopsis-based bounded error matching techniques as discussed herein can be extended for bounded error matching of multi-dimensional datasets in an efficient manner. For example, as noted above, the N-D to 1-D data mapping modules 144-1 and 154-1 (FIG. 1) implements methods that are configured to map a multi-dimensional dataset to a one-dimensional dataset (e.g., map multi-dimensional numerical elements of a dataset to 1-D numerical elements) to support the methods for 1-D bounded error matching of numeric datasets according to embodiments of the invention. In one embodiment, space filling curves are utilized to map multi-dimensional numerical elements to 1-D numerical elements, while preserving locality of the numerical values (linear order). A property of space filling curves is that when two points are near each other on a 1-D curve, then they are deemed to be near each other in 2-D space, but not necessarily vice versa.

For example, FIG. 4 schematically illustrates a method for mapping a 2-D numeric dataset to a 1-D numeric dataset to support bounded error matching of numeric datasets, according to an embodiment of the invention. In particular, FIG. 4 schematically illustrates a 2-D geometric space 400 comprising two datasets, wherein a first dataset comprises data elements 402 (illustrated as circles), and wherein a second dataset comprises data elements 404 (illustrated by X's). FIG. 4 further illustrates circles 410 (dashed line circles) around the data elements 402, wherein the circles 410 represent a region (i.e., band Δ) around the data elements 402 which corresponds to an error threshold (Δ) for determining data elements 404 of the second dataset which are related to the data elements 402 of the first dataset. In the example illustration, when a given data element 404 of the second dataset falls within a band 410 of a given data element 402 of the first dataset, the data elements 402 and 404 are deemed to be related.

In particular, FIG. 4 schematically illustrates a process of determining a Euclidean distance between a pair of 2-D data elements wherein the distance measure represents the mapping from 2-D to 1-D. The Euclidean distance is determined as a straight-line distance between two data elements in a Euclidean space. In the context of Euclidean geometry, a metric is established in one dimension by fixing the two points (e.g., 2-D points) on a line, and choosing one point to be the origin. The length of the line segment between the two points defines the unit of distance and the direction from the origin to the second point is defined as a positive direction. The 2-D data elements in the Euclidean space 400 shown in FIG. 4 can be mapped to 1-D data elements using suitable space filling curves and techniques, which are well known in the art.

For example, space filling curves can be implemented using Hilbert curves, as Hilbert curve mapping provides better locality preservation of values when compared to other types of space fulling curves. For example, Hilbert Curve mapping techniques can be utilized to map n-dimension values to 1-D values using Hilbert Space Filling Curves to map multi-dimensional values to one-dimensional values, wherein the multi-dimensional values are considered as coordinates of Hilbert curve. Following the mapping, a 1-D bounded error matching process as discussed herein can be used to process the 1-D values. These techniques can be generalized in a straight forward manner to map n-dimensional matching problem to 1-dimensional matching problem. One of the ways to reduce the error introduced when mapping from higher dimensional values to 1-D is by utilizing higher scales for the Hilbert coordinates.

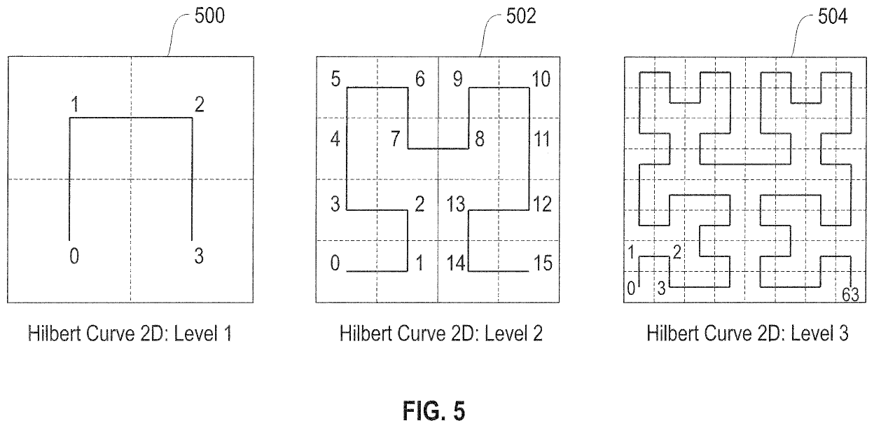

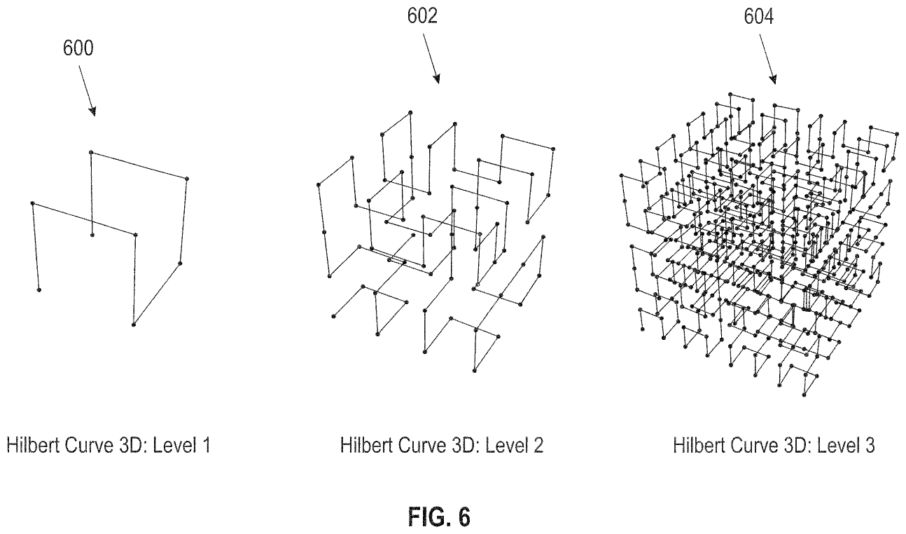

For example, FIG. 5 illustrates exemplary 2-D space filling curves that can be utilized to perform a curve mapping process to map a 2-D numeric dataset to a 1-D numeric dataset to support bounded error matching of numeric datasets, according to an embodiment of the invention. In particular, FIG. 5 illustrates a “level 1” 2-D Hilbert Curve 500, a “level 2” 2-D Hilbert Curve 502, and a “level 3” 2-D Hilbert Curve 504. In addition, FIG. 6 illustrates exemplary 3-D space filling curves that can be utilized to perform a curve mapping process to map a 3-D numeric dataset to a 1-D numeric dataset to support bounded error matching of numeric datasets, according to an embodiment of the invention. In particular, FIG. 6 illustrates a “level 1” 3-D Hilbert Curve 600, a “level 2” 3-D Hilbert Curve 602, and a “level 3” 3-D Hilbert Curve 604. The Hilbert Curves shown in FIGS. 5 and 6 can be utilized in conjunction with well-known techniques for mapping multi-dimensional data elements to 1-D elements.

The bounded error matching process of FIG. 3 as discussed above assumes that the error threshold value Δ is user-specified or otherwise known in advance. However, in some instances, the error threshold value Δ may not be specified or otherwise known in advance. Therefore, as noted above, in the absence of a pre-specified error threshold value Δ, the arbitrary band aggregation modules 146-1 and 156-1 (FIG. 1) are configured to generate a plurality (x) of different error threshold values (Δ₁, Δ₂, . . . Δₓ) according to a pre-specified protocol or set of rules, wherein a plurality (x) of synopsis data structures are constructed for a given dataset based on the set of error threshold values (Δ₁, Δ₂, . . . Δ_{X}). For example, FIG. 7 is a flow diagram of a method for performing bounded error matching of large scale numeric datasets when no error threshold is specified, according to another embodiment of the invention. The method of FIG. 7 is similar to the method of FIG. 3, except that the method of FIG. 7 implements an iterative method in which the method of FIG. 3 is performed in multiple iterations using different error threshold values within a range of error threshold values to compute a plurality of match scores, which are then used to determine the final match score.

In particular, referring to FIG. 7, an initial stage of the bounded error matching process comprises receiving X and Y numeric datasets without a pre-specified error threshold value Δ (block 700). The process flow proceeds to select an initial error threshold value Δ_{Initial} (block 702) and then perform a bounded error matching process to determine a match score between the X and Y datasets based on the selected error threshold value (block 703). In one embodiment, the initial error threshold value Δ_{Initial} is determined (in block 702) by starting with a small error threshold value such that each value from one input dataset (e.g., X) matches only a limited number of numeric values on the other input dataset (e.g., Y). Further, in one embodiment, the iteration of the bounded error matching process (block 704) is performed using the process flow of FIG. 3 as discussed above with the currently selected error threshold value.

The process can be repeated for multiple iterations to compute a match score between the datasets X and Y for different error threshold values. In one embodiment, a dynamic Δ doubling process is utilized wherein a new error threshold value is selected for each iteration by doubling the previously selected (and processed) error threshold value. As shown in FIG. 7, following the bounded error matching process of block 704, if it is determined that another iteration of the bounded error matching process is to be performed (affirmative determination in block 706), a new error threshold value is selected by increasing the value of the previously selected error threshold value (block 708), and the process flow continues (block 704) to perform another bounded error matching process to determine a match score based on the newly selected error threshold value. In one embodiment, the new error threshold value can be selected by, e.g., doubling, the previously selected error threshold value.

On the other hand, if it is determined that no further iteration is to be performed (negative determination in block 706), the process flow then proceeds to determine a final match score based on the spectrum of match scores previously estimated using the different selected error threshold values (block 710). In one embodiment, the final match score can be determined as an average of the spectrum of previously estimated match scores. In another embodiment, the final match score can be determined as a weighted average of the spectrum of previously estimated match scores wherein a given match score is penalized when the error threshold value used to compute that match score has been increased. In one embodiment, the number of iterations to be performed is a configurable parameter. For example, the number of iterations can be determined based on a minimum (min) and maximum (max) value of columns, wherein the number of iterations is no more than log₂(max-min).

Embodiments of the invention include a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Embodiments of the invention are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

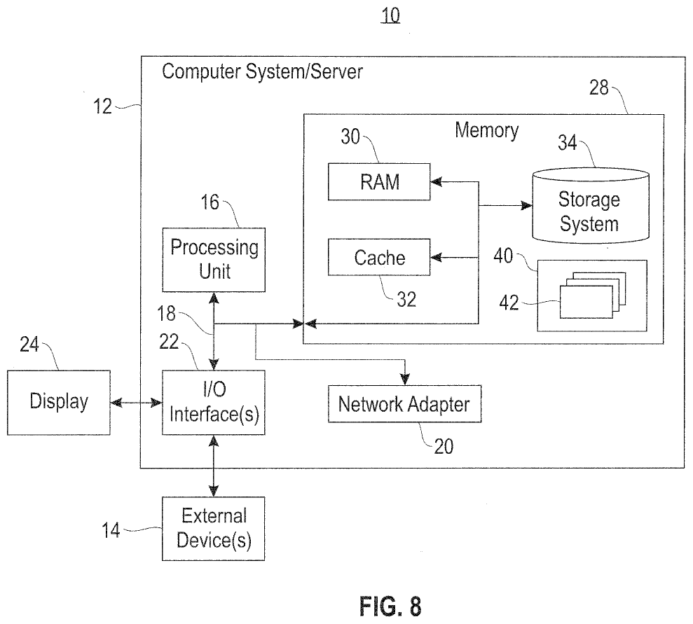

These concepts are illustrated with reference to FIG. 8, which shows a computing node 10 comprising a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

In FIG. 8, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

The bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 12 typically includes a variety of computer system readable media. Such media may be any available media that is accessible by computer system/server 12, and it includes both volatile and non-volatile media, removable and non-removable media.

The system memory 28 can include computer system readable media in the form of volatile memory, such as random-access memory (RAM) 30 and/or cache memory 32. The computer system/server 12 may further include other removable/non-removable, volatile/nonvolatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As depicted and described herein, memory 28 may include at least one program product having a set (e.g., at least one) of program modules that are configured to carry out the functions of embodiments of the invention.

The program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

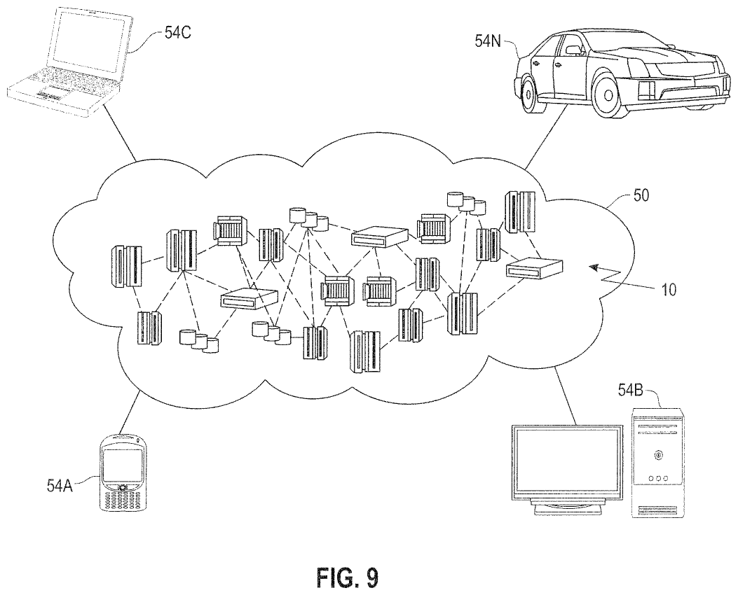

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

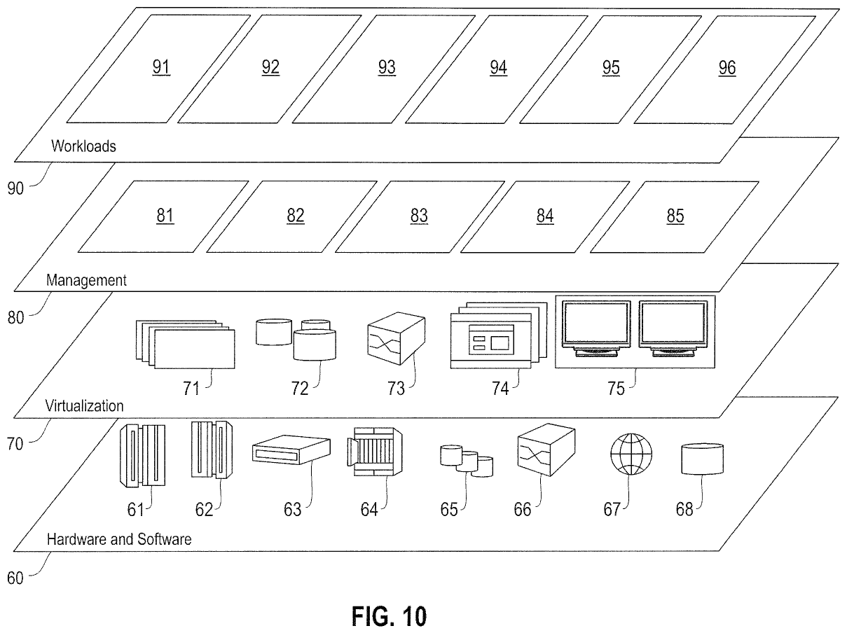

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and various functions implemented by the data processing platform 130 in FIG. 1, and in particular, the various functions of the system modules 140 and 150 of the computing platform 130, as discussed above to provide services for bounded error matching of large scale numeric datasets.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

Although exemplary embodiments have been described herein with reference to the accompanying figures, it is to be understood that the invention is not limited to those precise embodiments, and that various other changes and modifications may be made therein by one skilled in the art without departing from the scope of the appended claims.

What is claimed is:

1. A method comprising:
generating a first synopsis data structure of a first numeric dataset maintained in a data repository;
receiving a user query to search for numeric datasets in the data repository which are related to a second numeric dataset;
generating a second synopsis data structure of the second numeric dataset;
performing a bounded error matching process based on an error threshold value, wherein the bounded error matching process comprises comparing the second synopsis data structure to the first synopsis data structure, thereby determining a match score between the first and second numeric datasets, wherein the match score provides a measure of similarity between the first and second synopsis data structures of the first and second numeric datasets; and
responsive to results of the hounded error matching process, returning a query result to the user, wherein the query result comprises an identification of the first numeric dataset and the determined match score between the first and second numeric datasets.

2. The method of claim 1, wherein the first and second synopsis data structures each comprise a K-Minimum Value synopsis data structure.

3. The method of claim 1, further comprising:
performing a truncation process on numerical elements of the first numeric data set and the second numeric dataset, thereby generating a first truncated dataset and a second truncated dataset;
wherein the truncation process comprises applying a truncation operation to the first and second numeric datasets for converting real-number values of the first and second numeric datasets to integer values based on the error threshold value;
wherein generating the first synopsis data structure of the first numeric dataset comprises generating the first synopsis data structure using the first truncated dataset; and
wherein generating the second synopsis data structure of the second numeric dataset comprises generating the second synopsis data structure using the second truncated dataset.

4. The method of claim 3, wherein the truncation operation comprises transforming each numerical element D[i] of the first and second numeric datasets to an integer value by determining 2Δ*Math·floor (D[i]/2Δ), wherein Δ denotes the error threshold value.

5. The method of claim 3, further comprising:
performing a neighborhood preservation process on the first numeric data set, thereby generating a first neighborhood preserved dataset based on the numerical elements of the first numeric dataset, the first truncated dataset, and the error threshold value;
wherein generating the first synopsis data structure of the first numeric dataset comprises generating the first synopsis data structure using the first truncated dataset and the first neighborhood preserved dataset.

6. The method of claim 5, wherein performing the neighborhood preservation process comprises:
applying a neighborhood preservation operation on each numerical element D[i] of the first numeric dataset for determining if the numerical element D[i] is less than the sum of Δ and a corresponding truncated data value T_{D}[i] of the first truncated dataset T_{D}, wherein Δ denotes the error threshold value; and
responsive to determining that the given numerical element D[i] is less than the sum of Δ and the corresponding truncated data value T_{D}[i] of the first truncated dataset T_{D}, setting a corresponding neighborhood preserved value N_{D}[i] for the given numerical element D[i] equal to the truncated data value T_{D}[i] minus 2Δ; and
responsive to determining that the given numerical element D[i] is not less than the sum of Δ and a corresponding truncated data value T_{D}[i] of the first truncated dataset T_{D}, setting a corresponding neighborhood preserved value N_{D}[i] for the given numerical element D[i] equal to a sum of the truncated data value T_{D}[i] and 2Δ.

7. The method of claim 1, wherein the error threshold value is pre-specified.

8. The method of claim 1, wherein performing the bounded error matching process comprises performing an iterative bounded error matching process which comprises:
selecting a first error threshold value and performing a first iteration of the bounded error matching process for determining a first match score between the first and second numeric datasets based on the first error threshold value, wherein the first match score provides a measure of similarity between the first and second synopsis data structures of the first and second numeric datasets, wherein the first and second synopsis data structures in the first iteration are constructed based on the first error threshold value;
selecting a second error threshold value, which is greater than the first error threshold value, and performing a second iteration of the bounded error matching process for determining a second match score between the first and second numeric datasets based on the second error threshold value, wherein the second match score provides a measure of similarity between the first and second synopsis data structures of the first and second numeric datasets, wherein the first and second synopsis data structures in the second iteration are constructed based on the second error threshold value; and
determining a final match score using the first and second match scores.

9. The method of claim 1, wherein the first and second numeric datasets comprise multi-dimensional numerical elements, and wherein the method further comprises mapping the multi-dimensional numerical elements of the first and second numeric dataset to one-dimensional numerical elements prior to generating the first and second synopsis data structures.

10. The method of claim 9, wherein mapping the multi-dimensional numerical elements of the first and second numeric dataset to one-dimensional numerical elements is performed using a space filling curve.

11. An article of manufacture comprising a computer readable storage medium having program instructions embodied therewith, wherein the program instructions are executable by a computer to perform a method comprising:
generating a first synopsis data structure of a first numeric dataset maintained in a data repository;
receiving a user query to search for numeric datasets in the data repository which are related to a second numeric dataset;
generating a second synopsis data structure of the second numeric dataset;
performing a hounded error matching process based on an error threshold value, wherein the bounded error matching process comprises comparing the second synopsis data structure to the first synopsis data structure, thereby determining a match score between the first and second numeric datasets, wherein the match score provides a measure of similarity between the first and second synopsis data structures of the first and second numeric datasets; and
responsive to results of the bounded error matching process, returning a query result to the user, wherein the query result comprises an identification of the first numeric dataset and the determined match score between the first and second numeric datasets.

12. The article of manufacture of claim 11, wherein the first and second synopsis data structures each comprise a K-Minimum Value synopsis data structure.

13. The article of manufacture of claim 11, further comprising executable program instructions to perform a method comprising:
performing a truncation process on numerical elements of the first numeric data set and the second numeric dataset, thereby generating a first truncated dataset and a second truncated dataset;
wherein the truncation process comprises applying a truncation operation to the first and second numeric datasets for converting real-number values of the first and second numeric datasets to integer values based on the error threshold value;
wherein generating the first synopsis data structure of the first numeric dataset comprises generating the first synopsis data structure using the first truncated dataset; and
wherein generating the second synopsis data structure of the second numeric dataset comprises generating the second synopsis data structure using the second truncated dataset.

14. The article of manufacture of claim 13, further comprising executable program instructions to perform a method comprising:
performing a neighborhood preservation process on the first numeric data set, thereby generating a first neighborhood preserved dataset based on the numerical elements of the first numeric dataset, the first truncated dataset, and the error threshold value;
wherein generating the first synopsis data structure of the first numeric dataset comprises generating the first synopsis data structure using the first truncated dataset and the first neighborhood preserved dataset;
wherein performing the neighborhood preservation process comprises:
applying a neighborhood preservation operation on each numerical element D[i] of the first numeric dataset for determining if the numerical element D[i] is less than the sum of Δ and a corresponding truncated data value T_{D}[i] of the first truncated dataset T_{D}, wherein Δ denotes the error threshold value; and
responsive to determining that the given numerical element D[i] is less than the sum of Δ and the corresponding truncated data value T_{D}[i] of the first truncated dataset T_{D}, setting a corresponding neighborhood preserved value N_{D}[i] for the given numerical element D[i] equal to the truncated data value T_{D}[i] minus 2Δ; and
responsive to determining that the given numerical element D[i] is not less than the sum of Δ and a corresponding truncated data value T_{D}[i] of the first truncated dataset T_{D}, setting a corresponding neighborhood preserved value N_{D}[i] for the given numerical element D[i] equal to a sum of the truncated data value T_{D}[i] and 2Δ.

15. The article of manufacture of claim 11, wherein the error threshold value is pre-specified.

16. The article of manufacture of claim 11, wherein the hounded error matching process comprises an iterative process which comprises:
selecting a first error threshold value and performing a first iteration of the bounded error matching process for determining a first match score between the first and second numeric datasets based on the first error threshold value, wherein the first match score provides a measure of similarity between the first and second synopsis data structures of the first and second numeric datasets, wherein the first and second synopsis data structures in the first iteration are constructed based on the first error threshold value;
selecting a second error threshold value, which is greater than the first error threshold value, and performing a second iteration of the bounded error matching process for determining a second match score between the first and second numeric datasets based on the second error threshold value, wherein the second match score provides a measure of similarity between the first and second synopsis data structures of the first and second numeric datasets, wherein the first and second synopsis data structures in the second iteration are constructed based on the second error threshold value; and
determining a final match score using the first and second match scores.

17. The article of manufacture of claim 11, wherein the first and second numeric datasets comprise multi-dimensional values, wherein the method further comprises mapping the multi-dimensional values of the first and second numeric dataset to one-dimensional values prior to generating the first and second synopsis data structures, and wherein mapping the multi-dimensional values of the first and second numeric dataset to one-dimensional values is performed using a space filling curve.

18. A system, comprising:
a data processing platform of a service provider comprising computing modules executing on one or more computing nodes of a network, wherein the data processing computing platform is configured to:
generate a first synopsis data structure of a first numeric dataset maintained in a data repository;
receive a user query to search for numeric datasets in the data repository which are related to a second numeric dataset;
generate a second synopsis data structure of the second numeric dataset;
perform a bounded error matching process based on an error threshold value, wherein the hounded error matching process comprises comparing the second synopsis data structure to the first synopsis data structure, thereby determining a match score between the first and second numeric datasets, wherein the match score provides a measure of similarity between the first and second synopsis data structures of the first and second numeric datasets; and
responsive to results of the bounded error matching process, return a query result to the user, wherein the query result comprises an identification of the first numeric dataset and the determined match score between the first and second numeric datasets.

19. A method comprising:
maintaining a plurality of numeric datasets in a data repository;
generating synopsis data structures for each of the plurality of numeric datasets in the data repository, wherein the synopsis data structures are constructed based on an error threshold value;
generating a synopsis index comprising a plurality of index entries, wherein each index entry comprises a mapping of a given one of the synopsis data structures to an identifier of a corresponding numeric dataset in the data repository;
receiving a user query to search for target numeric datasets in the data repository which are related to a source numeric dataset specified by the user query;
generating a source synopsis data structure of the source numeric dataset based on the error threshold value;
searching through the index entries of the synopsis index and identifying synopsis data structures of target numeric datasets which have elements in common with elements of the source synopsis data structure;
determining a match score between the source synopsis data structure and each of the identified synopsis data structures, thereby generating a plurality of match scores, wherein a given match score provides a measure of similarity between the source numeric dataset and a given target numeric dataset in the data repository corresponding to a given one of the identified synopsis data structures; and
returning a query result to the user, wherein the query result comprises a ranked list which identifies a plurality of target numeric datasets in the data repository having highest-ranking match scores, out of the plurality of match scores, to the source numeric dataset.

20. The method of claim 19, wherein the synopsis data structures of the numeric datasets in the data repository and the source synopsis data structure of the source numeric dataset each comprise a K-Minimum Value synopsis data structure.
